(19) United States
(12) Patent Application Publication
(10) Pub. No.: US 2011/0011377 A1
(43) Pub. Date: Jan. 20, 2011

(54) CONSTRUCTION MACHINE

(75) Inventors: Taisuke Ikeda, Hiroshima (JP); Jumpei Yokota, Hiroshima (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KOBELCO CONSTRUCTION MACHINERY CO., LTD., Hiroshima-shi, Hiroshima (JP)

(21) Appl. No.: 12/866,562

(22) PCT Filed: Feb. 18, 2009
(86) PCT No.: PCT/JP2009/052743

§ 371 Date: Aug. 6, 2010

(30) Foreign Application Priority Data
Feb. 21, 2008 (JP) 2008-040348

(51) Int. Cl. F02M 25/07; F04D 29/52

(52) U.S. Cl. 123/568.12; 415/222

(57) ABSTRACT

The present invention provides a construction machine, capable of enhancing the cooling efficiency of an air-cooled cooler for EGR without deterioration of the cooling effect of a heat exchanger in spite of the arrangement of the air-cooled cooler for EGR near a cooling fan. The construction machine includes: an EGR line 20 for extracting and recirculating a part of exhaust gas from the exhaust side of an engine 9 to the intake side; and an air-cooled cooler 21 for EGR for cooling the recirculating gas flowing in the EGR line 20. The air-cooled cooler 21 for EGR is provided on the outer circumferential side of a cooling fan 11 in a position between the engine 9 and the cooling fan 11 or a position on the downstream side of the cooling fan 11, and cooled with cooling air flowing on the outer circumferential side of the cooling fan 11.

### FIELD OF THE INVENTION

The present invention relates to a construction machine such as a hydraulic excavator provided with an EGR device.

### BACKGROUND ART

Conventionally, as automobile emission control measures, an EGR (Exhaust Gas Recirculation) device for reducing NOx (nitrogen oxide) or PM (particulate matter) by extracting and recirculating a part of exhaust gas to the intake side to thereby reduce the combustion temperature is used, and adoption of the same device is requested also for construction machines such as a hydraulic excavator.

This EGR device requires cooling of extremely high-temperature exhaust gas to a temperature suitable for combustion of an engine, or the like. As this cooling technique, a technique shown in Patent Literature 1 is known. In this known technique, exhaust gas extracted from the exhaust side to an EGR line (exhaust gas recirculation line) is cooled by a water-cooled cooler for EGR using cooling water of a radiator and an air-cooled cooler for EGR using a cooling fan for cooling a heat exchanger including the radiator, and the resulting cooled gas is returned to the intake side through an EGR valve. The air-cooled cooler for EGR (hereinafter often referred simply to as air-cooled cooler) is provided on the front side of the cooling fan (on the upstream side of the flow of cooling air) while facing the entire surface of the cooling fan.

However, this known technique has the following problems.

1) The cooling fan (e.g., axial flow fan) which is generally used for construction machines has properties, as is well known, such that the pressure and flow rate of air flow (cooling air) generated by its rotation are relatively low on the inner circumferential side of the fan and high on the outer circumferential side thereof. Therefore, in the known technique in which the air-cooled cooler is disposed to face the entire surface of the fan, the air-cooled cooler is low in cooling effect on the inner circumferential side of the air-cooled cooler.

2) The longitudinally overlapping arrangement of the heat exchanger and the cooler causes increase in suction resistance of the cooling fan and reduction in cooling air quantity thereof.

The problems 1) and 2) result in not only deterioration of the cooling efficiency of the cooler (exhaust gas) but also deterioration of the cooling effect of the heat exchanger.

Further, since the cooling efficiency of the water-cooled cooler must be enhanced by due to the deteriorated cooling efficiency of the air-cooled cooler, the radiator that is a water source thereof must be enlarged. This leads to increased cost and makes the equipment layout difficult.

Patent Literature 1: Japanese Patent Application Laid-Open No. 2002-188526

### DISCLOSURE OF THE INVENTION

The present invention thus has an object to provide a construction machine, capable of enhancing the cooling efficiency of an air-cooled cooler for EGR without deterioration of the cooling effect of a heat exchanger in spite of the arrangement of the air-cooled cooler for EGR near a cooling fan. Therefore, a construction machine according to the present invention includes: an upper rotating body having an upper frame; a heat exchanger provided on the upper frame, the heat exchanger including an intercooler and a radiator; a cooling fan provided on the upper frame, the cooling fan rotating to generate cooling air for air-cooling the heat exchanger and having properties such that the pressure and flow rate of the cooling air generated by its rotation are relatively low on the inner circumferential side of the fan and high on the outer circumferential side thereof; an EGR line for extracting and recirculating a part of exhaust gas from the exhaust side of the engine to the intake side; and an air-cooled cooler for EGR for cooling the recirculating gas flowing in the EGR line. The air-cooled cooler for EGR is provided in a position on the outer circumferential side of the cooling fan so as to be cooled with the cooling air flowing on the outer circumferential side of the cooling fan.

### BRIEF DESCRIPTION OF THE DRAWINGS

FIG. 1 is a view showing an intake and exhaust system of an engine including an EGR device, according to a first embodiment of the present invention;

FIG. 2 is a front view of an air-cooled cooler for EGR of the EGR device shown in FIG. 1;

FIG. 3 is a view, that is similar as FIG. 1, showing an intake and exhaust system of an engine including an EGR device, according to a second embodiment of the present invention;

FIG. 4 is a front view, that is similar as FIG. 2, of an air-cooled cooler for EGR of the EGR device shown in FIG. 3; and

FIG. 5 is a schematic plan view showing a layout of an engine and the like in a hydraulic excavator provided with the intake and exhaust system of an engine according to the first and second embodiments.

### BEST MODE FOR CARRYING OUT THE INVENTION

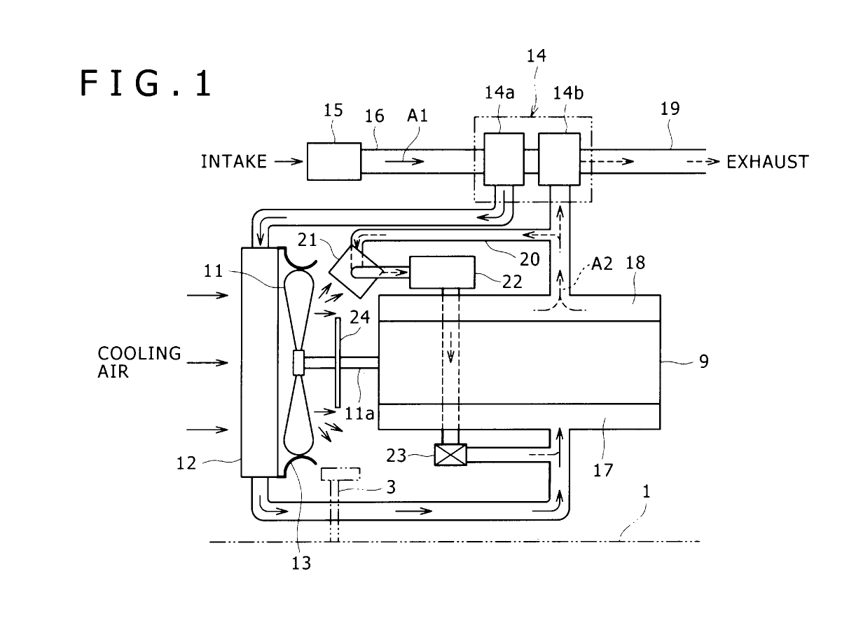

First and second embodiments of the present invention will be described in reference to FIGS. 1 to 4. These embodiments exemplify the application of the present invention to a hydraulic excavator.

FIG. 5 for illustrating a layout of engine and the like in a hydraulic excavator, which is exemplified for both the embodiments, shows an upper rotating body mounted on a lower traveling body. This upper rotating body includes an upper frame 1, and a working attachment, not shown, provided with a boom, an arm and a bucket, is installed at an end portion (an end portion on the left side in FIG. 5) of the upper frame 1. When the side where the attachment is installed is taken as the front side (hereinafter, the same side is the front side), a cabin 2 is installed on the left side of the front end of the upper frame 1.

A pair of left and right vertical plates 3 and 4 which is strengthening members, and partition walls 5, 6 and 7 are provided on the upper surface of the upper frame 1. The vertical plates 3 and 4 extend substantially across the entire area in the longitudinal direction of the upper frame 1 along a central section in the lateral direction thereof. The partition walls 5 to 7 are provided in the rear of the upper frame 1, the partition wall 5 being located in an area to the left of the left vertical plate 3, the partition wall 6 in an area between both the vertical plates 3 and 4, and the partition wall 7 in an area to the right of the right vertical plate 4. The partition walls 5 to 7 longitudinally divide the surface of the upper frame 1 to form an engine room 8 behind the partition walls or in a rear end portion of the upper frame. In the engine room 8, an engine 9 is provided between the left and right vertical plates 3 and 4, and a hydraulic pump 10 and cooling equipment for cooling the engine 9 are provided to the right and to the left of the engine 9, respectively.

The cooling equipment includes a cooling fan 11 disposed outside the left vertical plate 3 (on the opposite side of the vertical plate 3 to the engine 9), an intercooler 12 that is a heat exchanger, installed on the upstream side of the cooling fan 11, and a radiator and an oil cooler not shown which are also heat exchangers.

The cooling fan 11 rotates to generate cooling air for air-cooling the engine 9. As the cooling fan 11, a fan having properties such that the pressure and flow rate of the cooling air are relatively low on the inner circumferential side of the fan and high on the outer circumferential side (e.g., an axial flow fan) is used.

A shroud 13 is provided around the cooling fan 11 so as to cover the cooling fan 11 from the outer circumferential side. The shroud 13 has a shape (often called a bell mouth) such that it surrounds an opening at the center and the opening is gradually wider toward the engine 9, as shown in the drawing. The relative positions of the shroud 13 and the cooling fan 11 are set so as to attain both reduction in noise and increase in air quantity by the cooling fan 11.

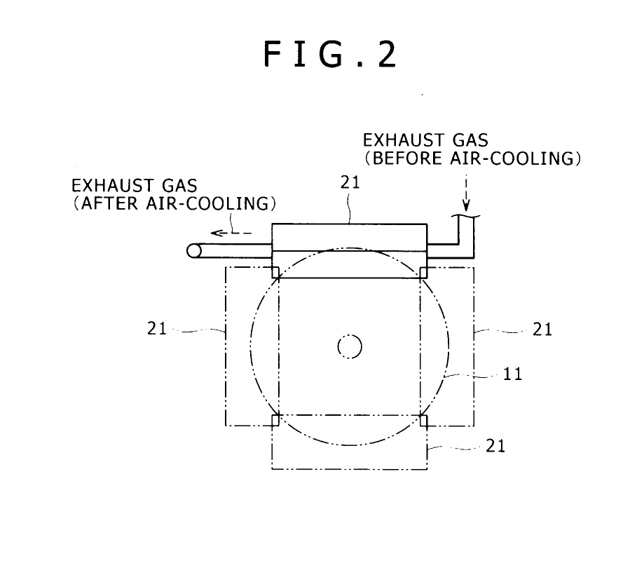

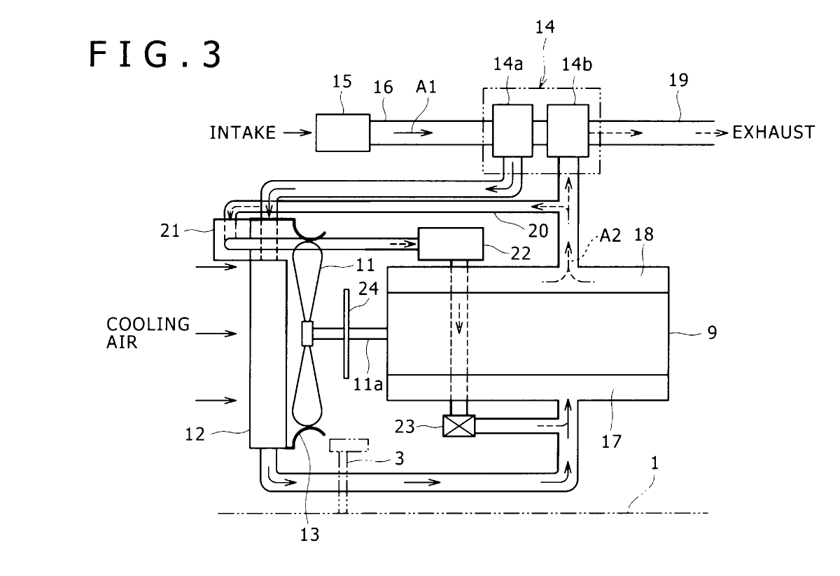

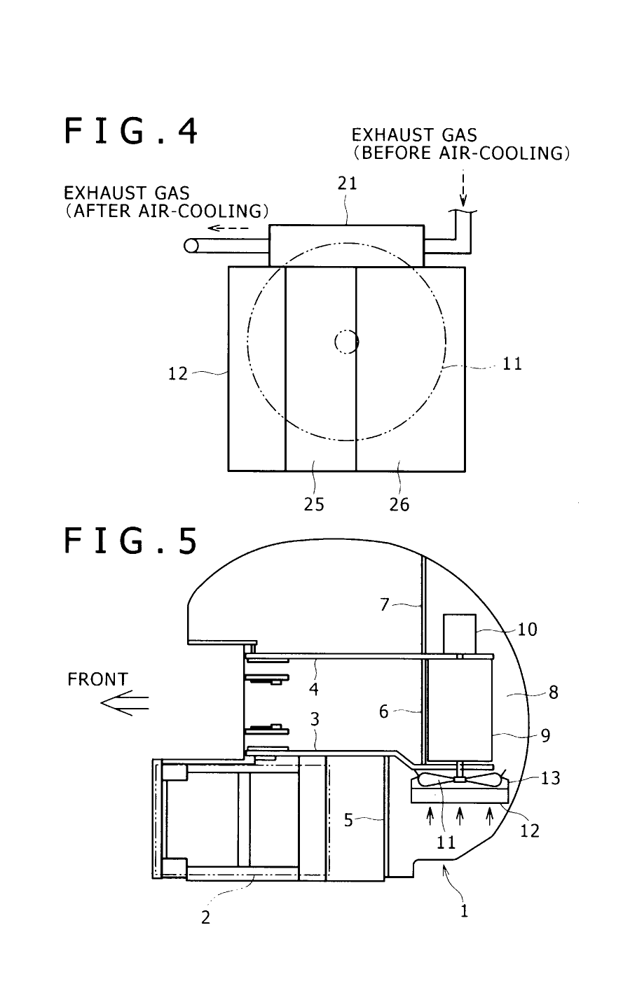

The first embodiment and the second embodiment are shown in FIGS. 1 and 2 and in FIGS. 3 and 4, respectively, on the assumption of such a layout of the upper frame 1.

### 1) First Embodiment

FIG. 1 shows an intake and exhaust system of an engine including an EGR device, according to the first embodiment. This system includes: a turbo charger 14 provided on the engine 9, an air cleaner 15, an intake pipe 16 and an exhaust pipe 19, an intake manifold 17 and an exhaust manifold 18, an EGR line 20, an air-cooled cooler 21 for EGR (hereinafter often referred simply to as air-cooled cooler), a water-cooled cooler 22 for EGR, and an EGR valve 23.

The turbo charger 14 includes a compressor 14a and a turbine 14b, and intake air A1 is introduced to the compressor 14a through the air cleaner 15 and the intake pipe 16. The intake air Al is pressurized by the compressor 14a, cooled by the intercooler 12, and then distributed to each cylinder of the engine 9 through the intake manifold 17.

Exhaust gas A2 is discharged from each cylinder. The exhaust gas A2 is sent to the turbine 14b of the turbo charger 14 through the exhaust manifold 18 to drive the turbine 14b, and then discharged out of a vehicle through the exhaust pipe 19.

On the other hand, a part of the exhaust gas A2 leaving the exhaust manifold 18 is extracted to the EGR line 20, air-cooled by the air-cooled cooler 21, and then further water-cooled by the water-cooled cooler 22 for EGR. The part of the exhaust gas A2 thus reduced in temperature is joined with the intake air cooled by the intercooler 12 through the EGR valve (a valve for adjusting the volume of recirculating gas) 23, and sent to the intake manifold 17. The exhaust gas recirculation is performed in this manner.

The cooling fan 11 is fixed to a leading end of a fan shaft 11a projecting from the engine 9. A resistance plate 24 formed in a disk shape smaller in diameter than that of the cooling fan 11 is attached to the outer circumference of an intermediate portion of the fan shaft 11a, or a section between the engine 9 and the cooling fan 11. The resistance plate 24 actively guides cooling air to the outer circumferential side of the fan while preventing back flow of the cooling air toward the center side of the fan with negative pressure.

The configuration described so far is the same as that of the second embodiment to be described later.

In the first embodiment, the air-cooled cooler 21 is provided in a position between the engine 9 and the cooling fan 11. Specifically, the cooler 21 is provided in a position above the left vertical plate 3 on the downstream side of the cooling fan 11, which becomes a part of the fan circumferential direction on the outer circumferential side of the cooling fan 11. In FIG. 1, the air-cooled cooler 21 is provided in the vicinity of the upper part of the cooling fan 11. However, the air-cooled cooler 21 may be provided in positions in the vicinity of the left, right or lower part of the cooling fan 11 seen from the front, as shown by the two-dot chain line in FIG. 2.

The air-cooled cooler 21 is provided, as shown in FIG. 1, in an inclined attitude such that the core surface of the air-cooled cooler 21 obliquely faces the cooling air flowing from the cooling fan 11 to the outer circumferential side thereof, and air-cools the exhaust gas A2 by performing heat exchange between the cooling air and the exhaust gas A2 at this place. Since the air-cooled cooler 21 has properties such that the pressure and flow rate of air flow generated by the rotation of the cooling fan 11 are basically low on the inner circumferential side of the cooling fan 11 and high on the outer circumferential side thereof, and is arranged to cool the exhaust gas A2 with of high-pressure and high-flow rate cooling air flowing on the outer circumferential side of the cooling fan 11, as described above, the cooling efficiency of the cooler 21 is remarkably enhanced, compared with the known technique.

By providing the air-cooled cooler 21 on the outer circumferential side of the cooling fan 11, the increase in suction resistance (reduction in cooling air quantity) of the cooling fan 11 can be suppressed, compared with the known technique in which the air-cooled cooler is disposed to face the entire surface of the fan, and the cooling effect required for the heat exchanger can be ensured.

Further, since the air-cooled cooler 21 is provided only in a position in a part of the circumferential direction of the cooling fan 11, the effect of suppressing the increase in suction resistance of the cooling fan 11 is further enhanced. Namely, the cooling efficiency of the air-cooled cooler 21 for EGR can be enhanced without deterioration of the cooling effect of the heat exchanger.

The exhaust gas reduced in temperature by the air-cooled cooler 21 then enters the water-cooled cooler 22, wherein it is further cooled by heat exchange with cooling water. The load of the water-cooled cooler 22 can be suppressed due to the enhanced cooling efficiency of the air-cooled cooler 21. This dispenses with the necessity of enlarging the radiator that is a water source.

Further, according to this embodiment, the following effects can be obtained.

(I) The air-cooled cooler 21 can be installed outside the shroud 13 since it is provided in a position between the engine 9 and the cooling fan 11 (on the downstream side of the cooling fan 11), or in a position close to the engine 9 on the outer circumferential side of the cooling fan 11. This eliminates limitation in the use of a rubber hose or an insulation, and facilitates the installation of the cooler 21 in the same vibration system as the engine 9.

(II) The air-cooled cooler 21 can be easily installed without formation of a new space for its installation, since the air-cooled cooler 21 is installed in a relatively large clearance which is originally formed by disposing the engine 9 and the cooling fan 11 on the right side and the left side, respectively, with respect to the left vertical plate 3 provided on the upper surface of the upper frame 1 as described above.

(III) The cooling air can be actively guided to the cooler 21 for EGR located on the outer circumferential side of the cooling fan 11 to further enhance the cooling efficiency, since the shroud 13 has the shape such that the opening is gradually wider toward the engine side, and the resistance plate 24 is provided on the outer circumference of the fan shaft 11a.

(IV) Since the air-cooled cooler 21 is provided in a position that becomes a part of the fan circumferential direction between the engine 9 and the cooling fan 11, and also provided in an inclined attitude such that it obliquely faces the cooling air flowing from the cooling fan 11 to the outer circumferential side, the quantity of cooling air passing through the air-cooled cooler 21 is increased, compared with the case in which the air-cooled cooler 21 is provided in a non-inclined attitude in the same position. This also contributes to the improvement in cooling efficiency.

(V) The load of the water-cooled cooler 22 for EGR is reduced since exhaust gas is air-cooled by the air-cooled cooler 21 for EGR and then cooled by the water-cooled cooler 22 for EGR. This results in a reduced load of the radiator that is the water source, and contributes to the reduction in size thereof.

The second embodiment will be then described based on FIGS. 3 and 4. In the second embodiment, the air-cooled cooler 21 for EGR is provided in a position further upstream of the intercooler 12 on the upstream side of the cooling fan 11.

According to the second embodiment, also, the following basic effects (A) and (B) can be obtained similarly to the first embodiment.

(A) The cooling efficiency of the air-cooled cooler 21 is remarkably increased, compared with the known technique, since the air-cooled cooler 21 is cooled with high-pressure and high flow-rate cooling air flowing on the outer circumferential side of the fan.

(B) The increase in suction resistance (the reduction in cooling air quantity) of the cooling fan 11 can be suppressed, compared with the known technique in which the air-cooled cooler is provided to face the entire surface of the fan, since the air-cooled cooler 21 is provided only in a position that becomes a part of the circumference of the fan on the outer circumferential side of the fan, and the cooling effect required for the heat exchanger can be ensured.

In the second embodiment, further, the cooler 21 for EGR is arranged so as to be offset from the intercooler 12, the oil cooler 25 and the radiator 26 which are heat exchangers in side view or front view, so that the air increased in temperature after cooling the cooler 21 for EGR to which exhaust gas before cooling having extremely high temperatures from 300 to 500° C. is introduced does not act on the heat exchangers 12, 25 and 26. Specifically, FIGS. 3 and 4 exemplify a case in which the cooler 21 for EGR is provided in an upward offset position relative to the heat exchangers 12, 25 and 26 when the cooler 21 for EGR is arranged in the vicinity of the upper part of the cooling fan 11. The cooler 21 for EGR can be provided in a downward offset position relative to the heat exchangers 12, 25 and 26, when the cooler 21 for EGR is provided in the vicinity of the lower part of the cooling fan 11. The cooler 21 for EGR can be provided with offset to the left side or right side relative to the heat exchangers 12, 25 and 26, when the cooler 21 for EGR is provided in the vicinity of the left part or right part of the cooling fan 11 as viewed from the front of the cooling fan 11. When the heat exchangers 12, 25 and 26 are disposed to entirely or partially overlap with the other exchangers in the flowing direction of cooling air, also, the cooler 21 for EGR can be arranged with offset so as not to overlap with the heat exchangers in the same manner as the above. Such arrangements can reduce the effect of the cooler 21 for EGR on the cooling action of the heat exchangers 12, 25 and 26.

In the first and second embodiments, the cooler 21 for EGR and the heat exchangers 12, 25 and 26 are provided to be positionally shifted to the upstream side and to the downstream side in the flowing direction of cooling air. However, these may be arranged to be vertically or laterally aligned.

If a problem such that a rubber hose, a urethane foam insulation, a rubber-based weather strip or the like is unusable can be solved, the air-cooled cooler 21 for EGR may be provided between the cooling fan 11 and the intercooler 12 (or on the front side of the cooling fan 11) within the shroud 13.

As described above, the present invention provides a construction machine, capable of enhancing the cooling efficiency of an air-cooled cooler for EGR without deterioration of the cooling effect of a heat exchanger in spite of the arrangement of the cooler near a cooling fan. Specifically, a construction machine according to the present invention includes an upper rotating body having an upper frame; a heat exchanger provided on the upper frame, the heat exchanger including an intercooler and a radiator; a cooling fan provided on the upper frame, the cooling fan rotating to generate cooling air for air-cooling the heat exchanger and having properties such that the pressure and flow rate of the cooling air generated by its rotation are relatively low on the inner circumferential side of the fan and high on the outer circumferential side thereof; an EGR line for extracting and recirculating a part of exhaust gas from the exhaust side of the engine to the intake side; and an air-cooled cooler for EGR for cooling the recirculating gas flowing in the EGR line. The air-cooled cooler for EGR is provided on the outer circumferential side of the cooling fan so as to be cooled with the cooling air flowing on the outer circumferential side of the fan.

In this construction machine, firstly, the cooling efficiency of the air-cooled cooler for EGR can be remarkably enhanced, compared with the known technique, since the air-cooled cooler for EGR is provided so as to be cooled with high-pressure and high flow-rate cooling air flowing on the outer circumferential side of the cooling fan. Secondarily, the increase in suction resistance (the reduction in cooling air quantity) of the cooling fan can be suppressed, compared with known technique in which a cooler is disposed to face the entire surface of the cooling fan, to ensure the cooling effect required for the heat exchanger, since the air-cooled cooler for EGR is provided on the outer circumferential side of the fan. Namely, the cooling efficiency of the air-cooled cooler for EGR can be enhanced without deterioration of the cooling effect of the heat exchanger. When a water-cooled cooler is used in combination, the load of the water-cooled cooler can be reduced due to the enhanced cooling efficiency of the air-cooled cooler, and this can solve the problem of the enlargement of the radiator that is the water source.

The air-cooled cooler for EGR is preferably provided in a position of a part of the circumferential direction of the cooling fan. According to this, the effect of suppressing the increase in suction resistance (the reduction in cooling air quantity) of the cooling fan is further enhanced.

According to the known technique in which the air-cooled cooler for EGR is arranged to the front of the cooling fan, the air-cooled cooler for EGR must be laid inside the shroud for covering the cooling fan from the outer circumferential side. In this case, since the exhaust gas to be introduced to the air-cooled cooler for EGR has high temperature, a rubber hose pipe, a urethane foam insulation for filling, a rubber-based weather strip or the like is unusable.

Further, although the air-cooled cooler for EGR is desirably installed so as to be included in a common vibration system with the engine, a bracket for supporting the air-cooled cooler for EGR must be extended largely from the engine side in the known technique since the air-cooled cooler for EGR is distant from the engine. This large overhang quantity of the bracket makes it difficult to ensure the strength of the bracket or piping. On the other hand, when the vibration system of the air-cooled cooler for EGR is separated from the vibration system of the engine, the piping connection around the air-cooled cooler for EGR is complicated.

In contrast, if the air-cooled cooler for EGR is provided on the outer circumferential side of the cooling fan between the engine and the cooling fan (on the downstream side of the cooling fan), the air-cooled cooler for EGR can be located in a position close to the engine but outside the shroud. This can solve the problem in which the use of the rubber hose, insulation or the like is limited, and allows the air-cooled cooler for EGR to belong to the common vibration system with the engine.

In a hydraulic excavator, generally, since left and right vertical plates that are strengthening members are longitudinally provided on the upper surface of the upper frame of the upper rotating body, and the engine and the cooling fan are disposed on one side and the other side, respectively, with respect to one of the vertical plates, a relatively large clearance is formed between the engine and the cooling fan. In such a layout, if the air-cooled cooler for EGR is provided between the engine and the cooling fan above the vertical plate, the air-cooled cooler for EGR can be easily installed without formation of a new installation space for the cooler by use of the above-mentioned clearance.

On the other hand, by forming the shroud for covering the cooling fan from the outside in such a shape that the opening is gradually wider toward the engine or by providing the resistance plate for guiding cooling air toward the outer circumference of the fan between the cooling fan and the engine, the cooling air can be guided to the air-cooled cooler for EGR to further enhance the cooling efficiency.

Further, if the air-cooled cooler for EGR is provided in an inclined attitude in which the air-cooling cooler for EGR obliquely faces the cooling air flowing from the cooling fan to the fan outer circumferential side on the assumption of a layout such that the air-cooled cooler for EGR is provided only in an area of a part of the circumferential direction of the cooling fan between the engine and the cooling fan, the quantity of cooling air passing through the air-cooled cooler for EGR can be increased to enhance the cooling efficiency, compared with a case in which the cooler is provided in an attitude such that it faces the cooing air but not be inclined in the same position.

The present invention is effective also for a case provided with an water-cooled cooler for EGR for further cooling exhaust gas cooled by the air-cooled cooler for EGR. In this case, since the gas cooled by the air-cooled cooler for EGR is introduced into the water-cooled cooler for EGR, the load of the water-cooled cooler for EGR is reduced. Consequently, the load of the radiator that is the water source can be further reduced.

1. A construction machine, comprising:
an upper rotating body having an upper frame;
a heat exchanger provided on said upper frame, said heat exchanger including an intercooler and a radiator;
a cooling fan provided on said upper frame, said cooling fan rotating to generate cooling air for air-cooling said heat exchanger and having properties such that the pressure and flow rate of the cooling air generated by its rotation are relatively low on the inner circumferential side of said fan and high on the outer circumferential side thereof;
an exhaust gas recirculation line for extracting and recirculating a part of exhaust gas from the exhaust side of the engine to the intake side; and
an air-cooled cooler for exhaust gas recirculation for cooling the recirculating gas flowing in said exhaust gas recirculation line, said air-cooled cooler for exhaust gas recirculation being provided in a position on the outer circumferential side of said cooling fan so as to be cooled with the cooling air flowing on the outer circumferential side of said cooling fan.

2. The construction machine according to claims 1, wherein said air-cooled cooler for exhaust gas recirculation is provided only in an area of a part of the circumferential direction of said cooling fan.

3. The construction machine according to claim 1, wherein said air-cooled cooler for exhaust gas recirculation is provided in a position on the outer circumferential side of said cooling fan between the engine and said cooling fan.

4. The construction machine according to claim 3, wherein a longitudinally extending vertical plate is provided on an upper surface of said upper frame, the engine and said cooling fan are provided on one side and on the other side, respectively, with respect to said vertical plate, and said air-cooled cooler for exhaust gas recirculation is provided between the engine and said cooling fan above said vertical plate.

5. The construction machine according to claim 3, wherein the construction machine further includes a shroud for covering said cooling fan from the outer circumference, and said shroud has a shape such that it surrounds an opening and the opening is gradually wider toward the engine side.

6. The construction machine according to claim 3, wherein a resistance plate for guiding the cooling air to the outer circumferential side of said cooling fan is provided between said cooling fan and the engine.

7. The construction machine according to claim 3, wherein said air-cooled cooler for exhaust gas recirculation is provided in an area of a part of the circumferential direction of said cooling fan in an inclined attitude in which it obliquely faces the cooling air flowing from said cooling fan to the outer circumferential side of said fan.

8. The construction machine according to claim 1, wherein the construction machine further includes a water-cooled cooler for exhaust gas recirculation for further cooling the exhaust gas cooled by said air-cooled cooler for exhaust gas recirculation.
